(19) United States
(12) Patent Application Publication
(10) Pub. No.: US 2011/0106820 A1
(43) Pub. Date: May 5, 2011

(54) VOLUNTEER SEARCH SYSTEM. VOLUNTEER SEARCH SERVER AND SEARCH METHOD THEREOF

(76) Inventors: Phone LIN, Taipei (TW); Ting-Yu Wang, Taipei (TW); Zih-Ci Lin, Taipei (TW); Shin-Neng Wang, Taipei (TW); Wei-Yen Lin, Taipei (TW); Yuguang Fang, Gainesville, FL (US)

(21) Appl. No.: 12/609,911

(22) Filed: Oct. 30, 2009

(51) Int. Cl. G06F 17/30

(52) U.S. Cl. 707/749; 707/E17.014; 707/E17.032

(57) ABSTRACT

The present invention discloses a volunteer search server, comprising a receiver, a database, an analyzer and a transmitter. The receiver is for receiving a request message from a requester, wherein the request message contains the location information of the requester. The database is for storing a matching mechanism and the location information of a plurality of volunteers. The analyzer is for exercising the matching mechanism to search at least one suitable volunteer according to the request message, wherein the matching mechanism considers both the location information of the requester and the volunteer. The transmitter is for transmitting a designate message to one designated volunteer. Additionally, the present invention discloses a search method of the volunteer search server and a volunteer search system thereof.

### BACKGROUND OF THE INVENTION

1. Technical Field

The present invention is related to a volunteer search system, wherein a volunteer search server can match at least one requester and a plurality of volunteers based on a database for the volunteer search server.

2. Description of the Prior Art

Referring to FIG. 1, what is shown is a diagram of the volunteer search system according to the prior art. The conventional volunteer search system 10 is manually operated, comprising at least one requester 11 and a volunteer group 130, wherein the volunteer group 130 consists of a plurality of volunteers 13, whose information may pre-stored in a database. When a requester 11 requires assistance, he sends the request to the system 10. Afterwards, the operator of the system 10 may search the database to find out one selected volunteer for the requester 11. Then, the operator may inform both the requester and the selected volunteer.

However, the selected volunteer 13 may not be a suitable person for the requester 11. Additionally, the task of searching the volunteer 13 may take too much time, i.e. hours to several days, including time to receive request, manually search database, and manually inform members. Therefore, a need has arisen to propose a novel volunteer search system and search method to provide customized and immediately search for the requester 11 when in need.

### SUMMARY OF THE INVENTION

It is a primary objective of the present invention to provide a volunteer search system, wherein the volunteer search server can exercise a matching mechanism to search at least one suitable volunteer according to the request message, and the matching mechanism can consider location information and/or the available time of the requester and the volunteer.

It is a secondary objective of the present invention to provide a volunteer search system, wherein the volunteer can provide real-time assistance to the requester by the volunteer search server.

It is still another objective of the present invention to provide a volunteer search system, wherein the requester and the volunteer both comprise a portable communication device for transmitting the request message and receiving the designate message, the portable communication devices of the volunteer and/or the requester comprise a Global Positioning System to provide real time location information and map to the volunteer and/or the requester.

It is still another objective of the present invention to provide a volunteer search system, wherein the portable communication devices of the volunteer and the requester have the function of short distance authentication to ensure security.

It is another objective of the present invention to provide a volunteer search server, wherein the requester and/or the volunteer can transmit an evaluation of the quality of the co-work between the volunteer and the requester to the volunteer search server to establish the reputation of volunteers.

It is still another objective of the present invention to provide a volunteer search server, wherein the volunteer search server can search at least one suitable volunteer according to the reputation information of the volunteer.

According to the above objectives, presented is a volunteer search system, comprising: at least one requester for transmitting a request message containing the location information of the requester; a plurality of volunteers for receiving a designate message; and a volunteer search server comprising a database with a matching mechanism stored inside, wherein the volunteer search server exercises the matching mechanism to search at least one suitable volunteer according to the request message, after one volunteer is designated, the volunteer search server transmits the designate message to the designated volunteer; wherein the database comprises the location information of the volunteers, and the matching mechanism considers both the location information of the requester and the volunteer.

According to the above objectives, presented is a volunteer search server, comprising: a receiver for receiving a request message from a requester, wherein the request message contains the location information of the requester; a database for storing a matching mechanism and the location information of a plurality of volunteers; an analyzer for exercising the matching mechanism to search at least one suitable volunteer according to the request message, wherein the matching mechanism considers both the location information of the requester and the volunteer; and a transmitter for transmitting a designate message to one designated volunteer.

According to the above objectives, presented is a search method of a volunteer search server, comprising the steps of: receiving a request message from a requester, wherein the request message contains the location information of the requester; exercising a matching mechanism to search at least one volunteer according to the request message, wherein the matching mechanism considers both the location information of the requester and a plurality of volunteers; and transmitting a designate message to a designated volunteer.

### BRIEF DESCRIPTION OF THE DRAWINGS

FIG. 1 is a diagram of the volunteer search system according to the prior art;

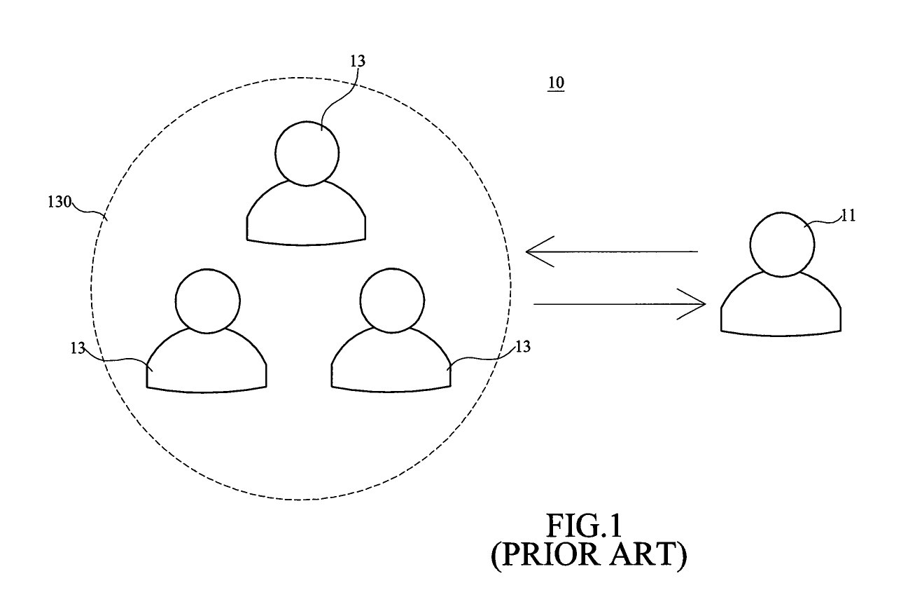

FIG. 2 is a schematic diagram of the volunteer search system according to an embodiment of the present invention;

FIG. 3 is a schematic diagram of the volunteer search server according to an embodiment of the present invention.

### DETAILED DESCRIPTION OF THE PREFERRED EMBODIMENTS

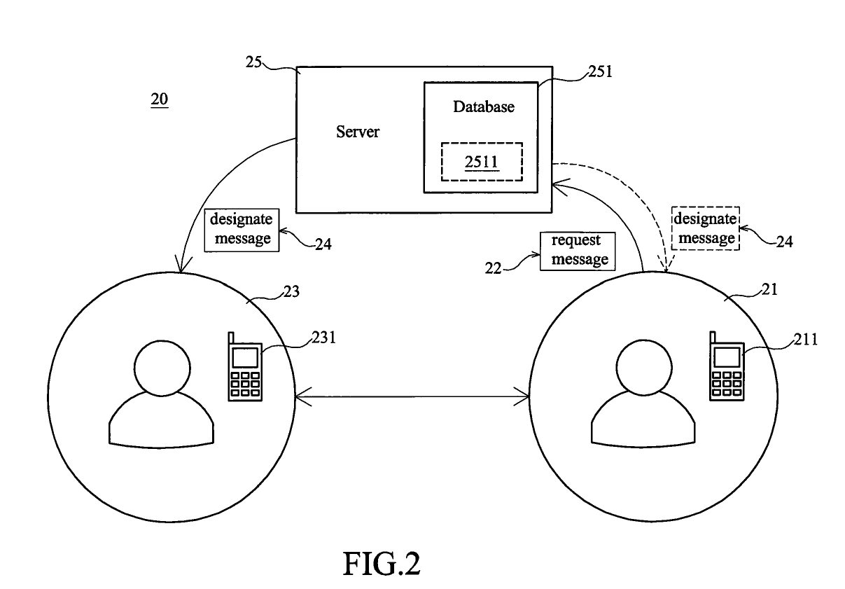

Referring to FIG. 2, a schematic diagram of the volunteer search system according to an embodiment of the present invention is disclosed. The volunteer search system 20 comprises at least one requester 21, a plurality of volunteers 23, and a volunteer search server 25. The requesters 21 and the volunteers 23 respectively communicate with the volunteer search server 25 (including wired and/or wireless communication).

The requesters 21 can be the people that need help, such as the elderly, women who are pregnant, and persons who are physically challenged. As a requester 21 needs assistance, he can transmit a request message 22 that contains the location information of the requester 21 to the volunteer search server 25 for asking help. The requester 21 comprises a communication device, a wireless communication device or a portable communication device 211 such as a computer, NB, mobile phone, etc., for transmitting the request message 22 to the volunteer search server 25. In addition, the communication between the requester 21 and the volunteer search server 25 can be based on mobile network or IP network, and so does the communication between the volunteer 23 and the volunteer search server 25.

When a person wants to become a volunteer 23 to help others, he can provide his profile, such as name, available time, location information and so on, to the volunteer search server 25. The volunteer search server 25 comprises a database 251 for storing the profile, such as the location information and/or the available time, of the volunteers 23. In an embodiment of the invention, the volunteer 23 can transmit his profile to the volunteer search server 25 via a portable communication device 231.

In addition, the database 251 of the volunteer search server 25 further comprises a matching mechanism 2511 stored inside. As the volunteer search server 25 receives the request message 22 from one of the requesters 21, the volunteer search server 25 will exercise the matching mechanism 2511 to search at least one suitable volunteer 23 according to the request message 22. For example, the database 251 comprises the location information of the volunteer 23, and the request message 22 comprises the location information of the requester 21, wherein the matching mechanism 2511 can consider both the location information of the requester 21 and the volunteer 23.

In one embodiment of the invention, the volunteer search server 25 may search a plurality of volunteers 23 for a requester 21, and the volunteer search server 25 or the requester 21 can designate one volunteer 23. After the volunteer 23 is designated, the volunteer search server 25 can transmit the designate message 24 to the designated volunteer 23.

In another embodiment of the invention, the database 251 comprises the location information and the available time of the volunteer 23, and the request message 22 comprises the location information and the available time of the requester 21, wherein the matching mechanism 2511 can consider both the location information and the available time of the requester 21 and the volunteer 23. For example, the volunteer search server 25 can find out a volunteer 23 with the same time slot and most close to the requester 21.

The available time may be the time that the volunteer 23 can provide service, and the location information may be the place in which the volunteer 23 lives. For example, the requester 21 could be a disabled person who lives in Taipei, and the volunteer search server 25 can arrange a volunteer 23 who also lives in Taipei to provide assistance for the requester 21. Moreover, the volunteer 23 can also provide the information of available service types for the requester 21 via the database 251 of the volunteer search server 25, so that the volunteer search server 25 can exercise the matching mechanism 2511 based on the service categories.

After the volunteer search server 25 finds a suitable volunteer 23 for the requester 21, the volunteer search server 25 will transmit a designate message 24 to the volunteer 23. Furthermore, the designate message 24 can comprise the time and location information of the requester 21, so that the volunteer 23 can know when and/or where he should meet with the requester 21 from the designate message 24. For example, the volunteer 23 comprises a communication device or a portable communication device 231, such as a computer, NB, mobile phone, etc., for receiving the designate message 24 from the volunteer search server 25, and the time and location information of the requester 21 can be shown on the portable communication device 231.

The volunteer search server 25 can also transmit the designate message 24 to the requester 21, too; so the requester 21, thereby, knows the volunteer search server 25 has arranged for him a suitable volunteer 23. Moreover, the requester 21 can know when and/or where the volunteer 23 will come from because of the designate message 24.

The portable communication devices 211 and 231 can both comprise a location map, such as a Global Positioning System (GPS), to provide the location information of the requester 21 and the volunteer 23. For example, the GPS can show the real-time location information of the requester 21 and the volunteer 23, such that the volunteer 23 can meet with the requester 21 by the GPS, and provide assistance for the requester 21.

Moreover, the portable communication device 211/231 can comprise a function of short distance authentication, and the identification of the requester 21 and the volunteer 23 can be processed by the short distance authentication to ensure security for each. For example, the requester 21 and the volunteer 23 can use a Bluetooth technology module within the portable communication device 211/231 to exercise the short distance authentication. In another embodiment of the invention, the designate message 24 can comprise an authentication code, and the volunteer search server 25 can transmit the authentication code to the requester 21 and the volunteer 23, so that the identification of the requester 21 and the volunteer 23 can be processed by the authentication code.

After the volunteer 23 has accomplished assisting the requester 21, the requester 21 and/or the volunteer 23 can exercise a feedback mechanism. The feedback mechanism can update the profiles of the volunteer 23 and/or the requester 21 in the database 251. For example, the requester 21 and/or the volunteer 23 can transmit an evaluation of the quality of the co-work between the volunteer 23 and the requester 21 to the volunteer search server 25, and the volunteer search server 25 can establish reputation information of the volunteer 23 by a plurality of evaluations from the same and/or different requesters 21. Moreover, the reputation information of the volunteer 23 can be stored in the database 251 of the volunteer search server 25, and the matching mechanism 2511 can search at least one suitable volunteer 23 according to the reputation information of the volunteer 23.

In one embodiment of the invention, there are a plurality of requesters 21 transmit evaluations to the volunteer search server 25, but the cognition of a requester 21 is often different from other requesters. Therefore, a T set and an R set can be established, wherein the T set can be the trusted experience set that records the experience of others by a requester, and the R set can be the recommender experience set that records the experience of others by recommenders (other requesters). For example, a requester (Alice) can transmit evaluations to the volunteer search server 25 to establish Alice's experience set (T set). Moreover, the volunteer search server 25 can establish Bob's experience set (T set), and the difference between Alice's experience set and Bob's experience set can be referred as an experience distance stored in the R set.

Furthermore, the volunteer search server 25 can exercise the matching mechanism 2511 to search at least one suitable volunteer 23 according to the T set and R set. For example, the matching mechanism 2511 can adjust Bob's experience set (T set) according to the experience distance between Bob and Alice (R set), and search at least one volunteer according the adjusted Bob's experience set for Alice.

In another embodiment of the invention, the request message 22 can comprise the available time and location information of the requester 21, and the volunteer search server 25 can receive the available time and location information of the requester 21 from the request message 22. In addition, the volunteer search server 25 receives the real-time location information of the requester 21 and the volunteer 23 via GPS, and the volunteer 23 can provide real-time assistance for the requester 21. Furthermore, the request message 22 can comprises further information, such as category of service, so that the volunteer search server 25 can figure out what kind of service the requester 21 needs, and find a volunteer 23 based on the request. For example, the requester 21 could be an elderly person, and need someone to take him someplace; so, the volunteer search server 25 can arrange a volunteer 23 with a driver's license to help the elderly person to a specific place by car.

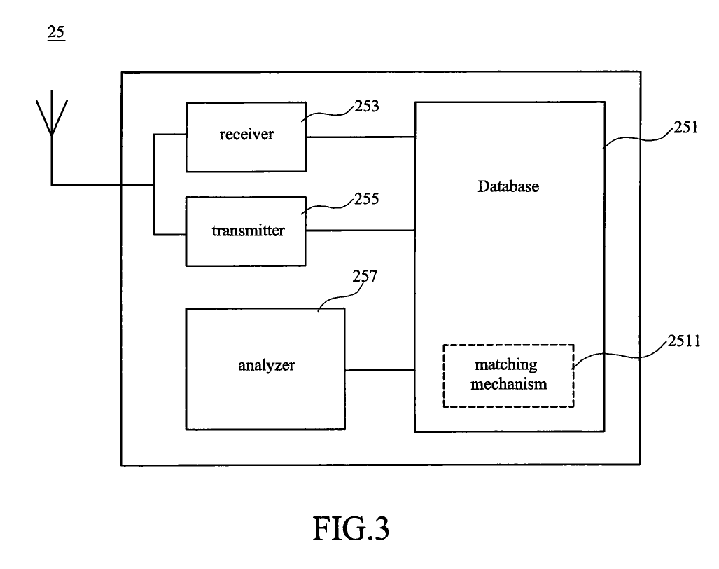

FIG. 3 is a schematic diagram of the volunteer search server according to an embodiment of the present invention. As shown in FIG. 2 and FIG. 3, the volunteer search server 25 comprises a database 251, a receiver 253, a transmitter 255, and an analyzer 257.

The receiver 253 can receive the requester message 22 from the requester 21, and the requester message 22 contains the location information and/or the available time of the requester 21. The database 251 stores a matching mechanism 2511 and the location information and/or the available time of a plurality of volunteers 23. After the request message 22 is received from the requester 21, the analyzer 257 of the volunteer search server 25 can exercise the matching mechanism 2511 to search at least one suitable volunteer 23 according to the request message 22. In addition, the matching mechanism 2511 can consider the location information and/or the available time of the requester 21 and the volunteer 23.

In one embodiment of the invention, the volunteer search server 25 may search a plurality of volunteers 23 for a requester 21, and the volunteer search server 25 or the requester 21 can designate one volunteer 23. After the volunteer 23 is designated, the transmitter 255 can transmit the designate message 24 to the designated volunteer 23.

The receiver 253 can receive at least one evaluation of the quality of the co-work between the volunteer 23 and the requester 21 from the requester 21 and/or the volunteer 23. The volunteer search server 25 can establish or update reputation information of the volunteer 23 according to a plurality of evaluations. Moreover, the reputation information of the volunteer 23 can be stored in the database 251, and the matching mechanism 2511 can search at least one suitable volunteer 23 according to the reputation information of the volunteer 23.

The above embodiments are only used to illustrate the present invention, and are not intended to limit the scope thereof. Many modifications of the above embodiments can be made without departing from the spirit of the present invention.

What is claimed is:

1. A volunteer search system, comprising:
at least one requester for transmitting a request message containing the location information of said requester;
a plurality of volunteers for receiving a designate message; and
a volunteer search server comprising a database with a matching mechanism stored inside, wherein said volunteer search server exercises said matching mechanism to search at least one suitable volunteer according to said request message, after one volunteer is designated, said volunteer search server transmits said designate message to said designated volunteer;
wherein said database comprises the location information of said volunteers, and said matching mechanism considers both the location information of said requester and said volunteer.

2. The volunteer search system of claim 1, wherein said matching mechanism considers both the available time of said requester and said volunteer.

3. The volunteer search system claim 2, wherein said database comprises the available time of said volunteers and said request message comprises the available time of said requester.

4. The volunteer search system claim 2, wherein said database comprises the available time of said volunteers and comprises the available time of said requester.

5. The volunteer search system claim 1, wherein said volunteer search server designates one volunteer for said requester.

6. The volunteer search system claim 1, wherein said requester designates one volunteer by himself.

7. The volunteer search system of claim 1, wherein said requester and/or said volunteer transmits an evaluation of the quality of the co-work between said volunteer and said requester to said volunteer search server.

8. The volunteer search system of claim 7, wherein said volunteer search server comprises reputation information of said volunteer established by a plurality of evaluations.

9. The volunteer search system of claim 8, wherein said matching mechanism considers the reputation information.

10. The volunteer search system of claim 1, wherein said requester and said volunteer both comprise a portable communication device for transmitting said request message and receiving said designate message.

11. The volunteer search system of claim 10, wherein said portable communication device comprises a function of short distance authentication.

12. The volunteer search system of claim 10, wherein said portable communication device comprises a Global Positioning System.

13. The volunteer search system of claim 1, wherein the communication between said requester and said volunteer search server is based on mobile network or IP network.

14. The volunteer search system of claim 1, wherein the communication between said volunteer and said volunteer search server is based on mobile network or IP network.

15. The volunteer search system of claim 1, wherein said volunteer search server transmits said designate message to said requester.

16. A volunteer search server, comprising:
a receiver for receiving a request message from a requester, wherein said request message contains the location information of said requester;
a database for storing a matching mechanism and the location information of a plurality of volunteers;
an analyzer for exercising said matching mechanism to search at least one suitable volunteer according to said request message, wherein said matching mechanism considers both the location information of said requester and said volunteer; and
a transmitter for transmitting a designate message to one designated volunteer.

17. The volunteer search server of claim 16, wherein said matching mechanism considers both the available time of said requester and said volunteer.

18. The volunteer search server of claim 16, wherein said requester and/or said volunteer transmits an evaluation of the quality of the co-work between said volunteer and said requester to said volunteer search server.

19. The volunteer search server of claim 18, wherein said volunteer search server comprises reputation information of said volunteer established by a plurality of evaluations.

20. The volunteer search server of claim 19, wherein said matching mechanism considers the reputation information.

21. A search method of a volunteer search server, comprising the steps of:
receiving a request message from a requester, wherein said request message contains the location information of said requester;
exercising a matching mechanism to search at least one volunteer according to said request message, wherein said matching mechanism considers both the location information of said requester and a plurality of volunteers; and
transmitting a designate message to a designated volunteer.

22. The search method of claim 21, wherein the matching mechanism further considering both the available time of said requester and said volunteers.

23. The search method of claim 21, further comprising the step of receiving at least one evaluation of the quality of the co-work between said volunteer and said requester from said requester and/or said volunteer.

24. The search method of claim 23, further comprising the step of establishing/updating reputation information of said volunteer based on said evaluation (s).

25. The search method of claim 24, wherein said matching mechanism considers the reputation information.
